(19) United States
(12) Patent Application Publication
(10) Pub. No.: US 2003/0071864 A1
(43) Pub. Date: Apr. 17, 2003

(54) Methods and apparatus for maintaining fluid ejector systems

(76) Inventor: Walter F. Walfer, Pittsford, NY (US)

Correspondence Address: OLIFF & BERRIDGE, PLC., P.O. BOX 19928, ALEXANDRIA, VA, 22320, US

(21) Appl. No.: 09/682,774

(22) Filed: Oct. 17, 2001

(51) Int. Cl. B41J 29/38

(52) U.S. Cl. 347/14

(57) ABSTRACT

A fluid ejector maintenance system for use with a fluid ejection system, including at least two fluid ejection nozzles, a detector that detects when at least one of the at least two fluid ejection nozzles ejects fluid onto a region, a controller that controls the other of the at least two fluid ejection nozzles said detector detects to eject fluid in the regions where fluid was previously ejected by the at least one fluid ejection nozzle.

### BACKGROUND OF THE INVENTION

1. Field of Invention

This invention relates to methods and apparatus for maintaining fluid ejector systems. In particular, the invention relates to methods and apparatus for maintaining fluid ejector systems by periodically providing drop ejection opportunities.

2. Description of Related Art

Fluid ejector systems, such as drop-on-demand liquid ink printers, utilize various methods to eject fluids including but not limited to piezoelectric, acoustic, phase change, wax-based and thermal systems. These systems include at least one fluid ejector from which droplets of fluid are ejected towards a recording medium, such as a sheet. A plurality of channels are defined within the fluid ejector. The fluid is disposed in the plurality of channels. Power pulses can cause the droplets of fluid to be expelled as required from orifices or nozzles that are defined at the end of each of the plurality of channels. A supply container supplies fluid to the plurality of channels.

In a thermal fluid ejection system, the power pulse is typically produced by heater transducers or resistors. A heater transducer or resister is typically provided for each of the channels. Each heater transducer or resistor is individually addressable to heat and vaporize fluid in one of the channels.

As voltage is applied across a selected heater transducer or resistor, a vapor bubble grows in the associated channel and initially bulges from the channel orifice. The vapor bubble then collapses. The fluid within the channel then retracts and separates from the bulging fluid to form a fluid droplet moving in a direction away from the channel orifice and towards the recording medium. When the fluid droplet contacts the recording medium, the fluid droplet forms a dot or spot of fluid on the recording medium. The channel is then refilled by capillary action, which, in turn, draws fluid from the supply container.

A fluid ejector can include one or more thermal fluid ejector dies having a heater portion and a channel portion. The channel portion typically includes an array of fluid channels that bring fluid into contact with the resistive heaters, which are correspondingly arranged on the heater portion. In addition, the heater portion may also have integrated addressing electronics and driver transistors. Since the array of channels in a single die assembly is typically not large enough to cover the entire length of the recording medium, the fluid ejector can either be scanned across the recording medium which is advanced between scans, or multiple die assemblies can be disposed adjacent to each other to produce a full-width fluid ejector.

Thermal fluid ejector nozzles typically produce spots or dots of a single size. Further, high quality fluid ejection is achieved by ejecting very small fluid droplets, which requires that the fluid channels and corresponding heaters be very small, such as, for example, on the order of 400-600 or more channels per inch.

Fluid ejectors can be utilized in many types of equipment. For example, fluid ejectors can be used in ink jet printheads that are incorporated into various types of printers, such as, for example, carriage-type printers, partial width array-type printers, and page-width type printers.

Carriage-type printers typically have a relatively small printhead containing the ink channels and nozzles. The printhead can be sealingly attached to a disposable ink supply cartridge. The combined printhead and cartridge assembly can be attached to a carriage that is reciprocated to print one swath of information at a time, on a stationary recording medium, such as a sheet, where each swath of information is equal to the length of a column of nozzles.

After the swath is printed, the recording medium is stepped a distance at most equal to the height of the printed swath so that the next printed swath is contiguous or overlaps with the previously printed swath. This procedure is repeated until the entire image is printed.

In contrast, page-width type printers typically include a stationary printhead having a length that is sufficient to print across the width or length of the recording medium. The recording medium is continually moved past a page-width printhead in a direction substantially normal to the printhead length and at a constant or varying speed during the printing process. A page width fluid ejector printer is described, for instance, in U.S. Pat. No. 5,1 92,959, which is incorporated herein by reference in its entirety.

Fluid ejection systems typically eject fluid drops based on information received from an information output device, such as a personal computer. Typically, the received information is in the form of a raster, such as, for example, a full page bitmap or in the form of an image written in a page description language. The raster includes a series of scan lines that include bits representing individual information elements. Each scan line contains information sufficient to eject a single line of fluid droplets across the receiving medium in a linear fashion. For example, fluid ejecting printers can print bitmap information as received or can print an image written in the page description language once it is converted to a bitmap of pixel information.

### SUMMARY OF THE INVENTION

The fluid-ejecting nozzles of conventional fluid ejector systems of the types discussed above need to be maintained, for example, by periodically cleaning the nozzles when the fluid ejector systems are in use, and/or by capping the nozzles when the fluid ejector systems are out of use or idle for extended periods. Capping the nozzles is intended to prevent the fluid in the nozzles from drying up. The cap provides a controlled environment to prevent fluid exposed in the nozzles from drying out.

However, capping the nozzles is only available when the fluid ejector is out of use or is idle for extended periods. If the nozzles are periodically cleaned when the fluid ejector system is in use, then the nozzles must be moved to a maintenance station where the cleaning process is performed. In this case, the carriage containing the nozzles travels to the maintenance station, which is spaced from the fluid ejecting zone. Various maintenance functions can be performed on the one or more nozzles when they are disposed at the maintenance station.

Typically, after the fluid ejector system nozzles arrive at a maintenance station, a few droplets are fired from each channel into a spittoon. However, the extra time required for moving the fluid ejector system nozzles to the maintenance station slows down the fluid ejecting process.

Specifically, because the maintenance station must be spaced apart from the fluid ejecting zone, additional time is needed to move the fluid ejector system nozzles to the maintenance station and then back to the fluid ejecting zone. This travel time back and forth to the maintenance station is repeated each time the fluid ejector system requires maintenance. The maintenance functions performed at the maintenance stations take even more time, which results in an even longer fluid ejecting time. Maintenance and/or priming stations of print heads for various types of ink jet printers are disclosed in, for example, U.S. Pat. Nos. 4,364,065; 4,855,764; 4,853,717 and 4,746,938, which are incorporated herein by reference.

This invention provides systems and methods that reduce fluid ejection time. This invention also provides systems and methods that maintain fluid ejection nozzles by periodically providing drop ejection opportunities.

In various exemplary embodiments of the invention, a fluid ejector system includes at least two types of fluid that are ejected from at least two nozzles associated with each of the at least two fluids.

Various exemplary embodiments of the systems and methods according to the invention include a counter that tracks the number of ejections of the nozzle that ejects the fluid. After the counter has determined that a pre-determined number of ejections have taken place, the nozzles which eject the at least second fluid are driven to eject maintenance drops onto the regions of the surface in which the first fluid has previously been ejected. In various exemplary embodiments of the invention, the counter may be a mechanical counter, a software counter or any known or later developed counter that keeps track of the number of ejections.

Various other exemplary embodiments of the systems and methods according to the invention include a timer that keeps track of the period of time that the nozzle that ejects fluid has ejected fluid. After the timer has sensed that a predetermined period of time has passed, the nozzles which eject the at least second fluid will eject maintenance drops onto the regions of the surface in which the first fluid has previously been ejected.

A system that allows the fluid ejector system nozzles to fire maintenance drops onto regions of the surface onto which fluid is being ejected saves time. This is because the fluid ejector system nozzles do not require the time to travel from the fluid ejection zone to the maintenance station.

Various other exemplary embodiments of the systems and methods according to this invention include a fluid ejector system with environmental condition sensor devices and a processor. The environmental condition sensor devices include at least one of a temperature sensing device, a humidity sensing device, and an environmental pressure sensing device. However, it should be appreciated that any known or later developed sensing device that senses a condition that affects the ability of nozzles to eject fluid may be used in the fluid ejector system. In various exemplary embodiments of the invention, the one or more environmental condition sensors send a signal to the processor to adjust the maintenance routine based on the sensed conditions.

Various exemplary embodiments of the systems and methods of this invention include fluid-characteristic detecting devices that adjust the ejection of the maintenance drops in accordance with the detected characteristics of the fluid. In various exemplary embodiments of the invention, the period between maintenance ejections is adjusted based on the viscosity of the fluid. In various exemplary embodiments of the invention, the viscosity of the fluid will affect the number of maintenance drops that are ejected. In various other exemplary embodiments of the invention, the age or manufacturer of the fluid may affect the maintenance ejection routine. However, it should be appreciated that any known or later determined fluid characteristic that affects the required maintenance interval may be sensed to adjust the maintenance routine based on the sensed conditions.

In various exemplary embodiments of the invention, a processor communicates with the environmental condition sensors, and/or the fluid characteristic sensors, and adjusts the maintenance drop ejecting routine in accordance thereto.

Various exemplary embodiments of the systems and methods according to the invention include manually implementing the maintenance routine or manually adjusting the counters and/or timers that control the maintenance routine interval.

Other various exemplary embodiments of the invention include adjusting the environmental condition and fluid characteristic programs relative to one another.

In various exemplary embodiments of the invention, the fluid ejection system is an ink jet printer using pigment based inks and dye based inks.

Various exemplary embodiments of the systems and methods of this invention include a quality sensing device that determines the fluid ejection quality and determines if the quality of the fluid ejection process is reduced due to the effects of fluid drying in the nozzles or some other condition that requires maintenance. The maintenance routine may then be performed or adjusted based on the maintenance requirements.

These and other features and advantages of this invention are described in, or are apparent from, the following detailed description of various exemplary embodiments of the systems and methods according to this invention.

### BRIEF DESCRIPTION OF THE DRAWINGS

Various exemplary embodiments of this invention will be described in detail, with reference to the following figures, wherein:

FIG. 1 is a block diagram of one exemplary embodiment of an image-forming apparatus including counters to track the number of fluid nozzle ejections;

FIG. 2 is a regular and magnified section showing dye-based ink portions which have been ejected into pigment-based ink portions;

FIG. 3 is a flow diagram of one exemplary embodiment according to the invention using ejection tracking counters;

FIG. 4 is a flow diagram of one exemplary embodiment according to the invention using ejection tracking counters;

FIG. 5 is a flow diagram of one exemplary embodiment according to the invention using time tracking counters; and

FIG. 6 is a flow diagram of one exemplary embodiment according to the invention using time tracking counters.

### DETAILED DESCRIPTION OF PREFERRED EMBODIMENTS

The following detailed description of various exemplary embodiments of the fluid ejection systems according to this invention are directed to one specific type of fluid ejection system, an ink jet printer, for the sake of clarity and familiarity. However, it should be appreciated that the principles of this invention, as outlined and/or discussed below, can be equally applied to any known or later developed fluid ejection systems, other than the ink jet printer specifically discussed herein.

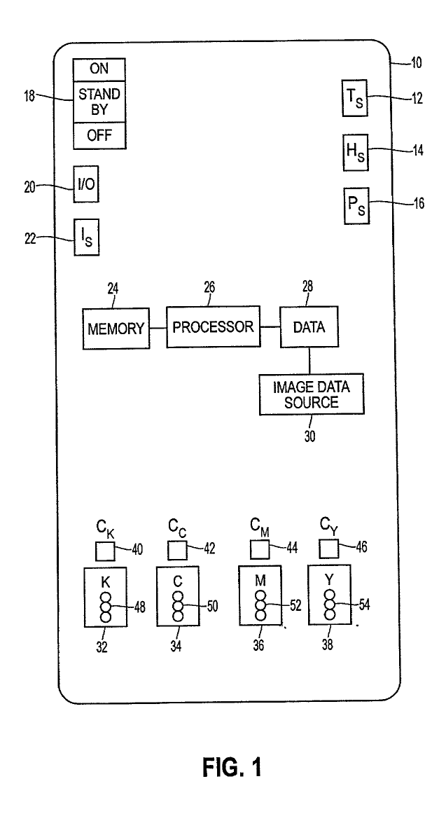

FIG. 1 is a block diagram of an image-forming apparatus 10 that incorporates nozzles 48, 50, 52 and 54 that eject pigment-based inks and dye-based inks. The nozzles 50, 52 and 54 eject dye-based inks. The nozzles 50, 52, and 54 eject maintenance drop regions 2, 3 and 4 onto the regions 1 of the media that contains pigment-based inks. The image forming apparatus 10 includes pigment-based ink jet nozzles 48 on print head 32, dye-based ink jet nozzles 50, 52 and 54 on print heads 34, 36 and 38, and counters 40, 42, 44 and 46 for each respective nozzle. A memory 24, processor 26, image data source 30 and data 28 are also shown.

In general, the image data source 30 can be any one of a number of different sources, such as a scanner, a digital copier, a facsimile device that is suitable for generating electronic image data, or a device suitable for storing and/or transmitting electronic image data, such as a client or server of a network, or the Internet, and especially the World Wide Web. For example, the image data source 100 may be a scanner, or a data carrier such as a magnetic storage disk, CD-ROM or the like, or a host computer, that contains scanned image data.

Thus, the image data source 30 can be any known or later developed source that is capable of providing image data to the processor 26 of this invention.

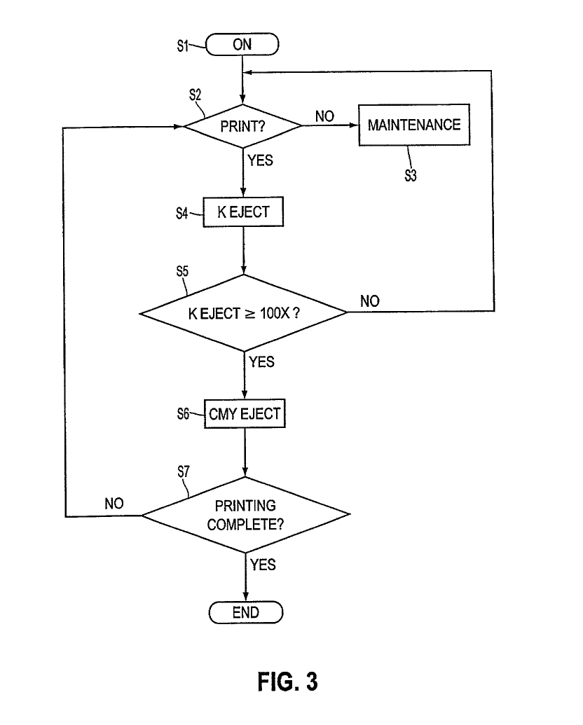

The functions of the processor may be implemented on a programmed general purpose computer. However, the processor functions can also be implemented on a special purpose computer, a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA or PAL, or the like. In general, any device, capable of implementing a finite state machine that is in turn capable of implementing the flowcharts shown in FIGS. 3-6, can be used to implement the processor functions.

The memory 24 can be implemented using any appropriate combination of alterable, volatile or non-volatile memory of non-alterable, or fixed, memory. The alterable memory, whether volatile or non-volatile, can be implemented using any one or more of static or dynamic RAM, a floppy disk and disk drive, a writable or re-writeable optical disk and disk drive, a hard drive, flash memory or the like. Similarly, the non-alterable or fixed memory can be implemented using any one or more of ROM, PROM, EPROM, EEPROM, an optical ROM disk, such as a CD-ROM or DVD-ROM disk, and disk drive or the like.

The image forming apparatus can include one or more atmospheric condition sensor devices. The atmospheric condition sensor devices may include at least one or more of a temperature sensing device 12, humidity sensing device 14 or an atmospheric pressure sensing device 16. However, it should be appreciated that any known or later developed sensor that senses an external condition that may change the maintenance requirement interval of the inkjet nozzles can be used.

The image forming apparatus 10 may also include at least one ink characteristic sensor 22. The ink characteristic sensor 22 may include one or more of a viscosity sensor, an ink age sensor or any other known or later developed sensor that detects an ink characteristic that affects the ink jet nozzle maintenance requirement interval.

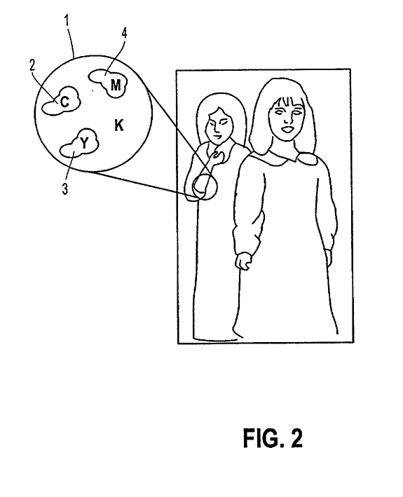

FIG. 3 illustrates one exemplary embodiment of the invention. In step S1 the image forming apparatus 10 is switched on. In step S2 it is determined if the image forming apparatus is printing. If the image forming apparatus is not currently printing, control flows to step S3. In step S3, the image forming apparatus 10 will go into a conventional maintenance routine for periodically ejecting ink from ink jet nozzles 48, 50, 52 and 54. It should be appreciated that in this and other exemplary embodiments of the invention step S3 is not required and that the methods and systems of the invention perform equally well in a fluid ejector system without a standard maintenance routine outside that disclosed in the invention. In step S4 it is determined if the dye-based ink, which is black in the embodiment, is ejected onto the media to form regions 1. If the black ink is not being ejected onto the media, control flows back to step 52. If the black ink is being ejected, control flows to step S5. In step S5 the counter 40 tracks the number of ejections made by black ink jet nozzle 48. When the counter reaches a predetermined number, 100 ejections in FIG. 3, the control flows to step S6. If the number of ejections does not reach 100, control flows to step S2. If the ejections are greater than or equal to 100 in step S5, the control flows to step S6 where the pigment-based ink jet nozzles 50, 52 and 54, cyan, magenta and yellow respectively in the embodiment, eject maintenance drops onto region 1 of the media that already contains dye-based ink. The ejection of maintenance drops onto regions 1 of dye-based ink is shown in FIG. 2. In FIG. 2, regions 2, 3 and 4 consist of drops of cyan, magenta and yellow ink ejected onto region 1. These regions 2, 3 and 4 are indistinguishable to the unaided human eye and do not affect the appearance of the media.

It should be appreciated that in various exemplary embodiments of the invention the number of ejections of the black ink jet nozzle 48 that are counted before proceeding to step 6 may be any number. In various exemplary embodiments the number of ejections may be any predetermined number. In various other exemplary embodiments the number may be adjusted up or down. The number of ejections of the black ink jet nozzle may be adjusted manually by the user if the user notes a degradation in the quality of the CMY regions. Likewise, in this and various other exemplary embodiments of the invention, a user may manually adjust the number of maintenance drops ejected by nozzles 50, 52 and 54.

The number of black ink ejections may be adjusted by a processor 25 in communication with one or more environmental condition sensors 12, 14 and 16. Environmental condition sensors 12, 14 and 16 sense environmental conditions such as temperature 12, humidity 14 and atmospheric pressure 16. It should be appreciated that any environmental condition that will affect the required maintenance schedule of the ink jet nozzles 50, 52 and 54 may be sensed and used to adjust the maintenance interval. The environmental condition sensors send a signal to the processor 26 which contains numerical value information related to the sensed condition. The value or combination of values can act as a pointer to an entry in a look-up table that contains various potential values related to the number of black ink jet nozzle 48 ejections. The number of black ink jet nozzle ejections required before proceeding to step S6 may be adjusted based on the value or combination of values. It should be appreciated that the counter used to track the number of ejections of the ink jet nozzles may be any currently known or later developed counter.

In another exemplary embodiment of the invention the number of ejections of the black ink jet nozzle 48 that are counted before proceeding to step S6 may be adjusted by processor 26 in communication with one or more ink characteristic sensors 22. Ink characteristic sensors 22 sense characteristics such as ink viscosity, ink age and/or manufacturer. It should be appreciated that any ink characteristic that will affect the required maintenance schedule or ink nozzle 50, 52 or 54 performance may be sensed and used to adjust the maintenance interval. The one or more ink characteristic sensors send a signal to processor 26 which contains numerical value information related to the sensed condition. The value or combination of values can act as a pointer to an entry in a look up table that contains various potential values related to the number of black ink jet nozzle 48 ejections. The number of black ink jet nozzle ejections required before proceeding to step S6 may be adjusted based on the value or combination of values.

It should be appreciated that one or more values related to environmental conditions may be combined with one or more values related to ink characteristics to act as a pointer to an entry in a look up table. In various other exemplary embodiments of the invention, the number of maintenance drops that are ejected by pigment-based ink nozzles 50, 52 and 54 may be adjusted based on conditions sensed by one or more environmental condition sensors alone or in conjunction with the ink characteristic sensors.

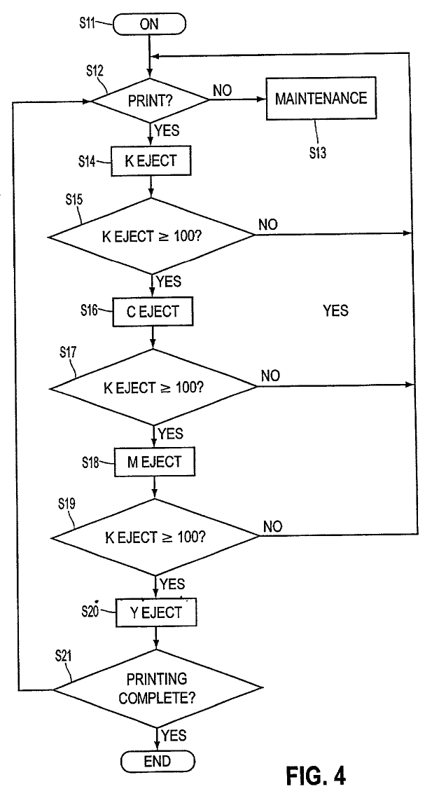

FIG. 4 illustrates another exemplary embodiment of the invention. In step S11 the image forming apparatus is switched on. In step S12 it is determined if the image forming apparatus 10 is printing. If the image forming apparatus is not currently printing, control flows to step S13. In step S13 the image forming apparatus 10 goes into a conventional maintenance routine for periodically ejecting ink from ink jet nozzles 48, 50, 52 and 54.

In step S14 it is determined if the dye-based ink, which is black in the embodiment, is ejected onto the media to form regions 1. If the black ink is not being ejected onto the media, control flows back to step S12. If the black ink is being ejected, control flows to step S15. In step S15 the counter 40 tracks the number of ejections made by black ink jet nozzle 48. When the counter reaches a predetermined number, 100 ejections in step S15, the control flows to step S16. If the number of ejections does not reach 100, then control flows to step S12. In step S16 pigment-based ink jet nozzle 50 for cyan ejects maintenance drops onto regions 1 of the media that already contain dye-based ink. After the ink jet nozzle 50 for cyan has ejected its maintenance drops control flows to step S17. In step S17 the counter 40 again tracks the number of ejections made by black ink jet nozzles 48. When the counter reaches a predetermined number, 100 ejections in step S17, the control flows to step S18. If the number of ejections does not reach 100, control flows to step S12. In step S18, pigment-based ink jet nozzle 52 for magenta ejects maintenance drops onto regions 1 on the media that already contain dye-based ink. After the ink jet nozzle 52 for magenta has ejected its maintenance drops, control flows to step S19. In step S19 the counter 40 again tracks the number of ejections made by black ink jet nozzle 48. When the counter reaches a predetermined number, 100 ejections in step 19, then control flows to step S20. If the number of ejections does not reach 100, control flows to step S12. In step S21 pigment-based ink jet nozzle 54 for yellow ejects maintenance drops onto regions 1 on the media that already contain dye-based ink.

It should be appreciated that in various exemplary embodiments the number of ejections set in steps S5, S15, S17 and S19 can be any appropriate number. In various other exemplary embodiments the number of ejections may be adjusted up or down, manually, in cooperation with environmental condition sensors and/or ink characteristic sensors or any known or later developed sensor that senses a condition that affects the required maintenance schedule of the inkjet nozzles 50, 52 and 54.

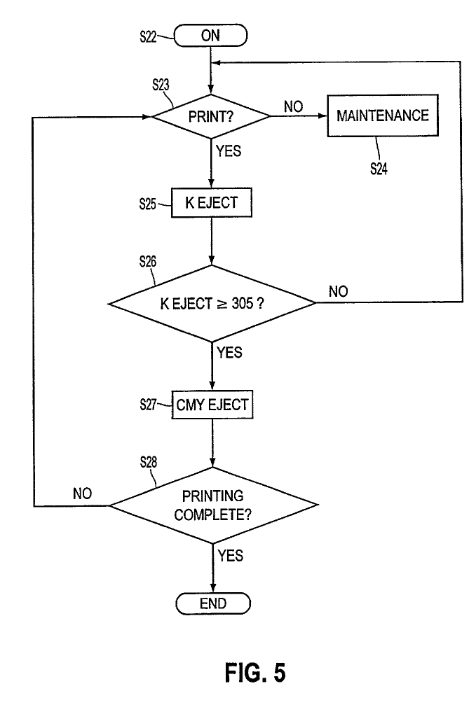

FIG. 5 illustrates another exemplary embodiment of the invention. In step S22, the image forming apparatus 10 is switched on. In step S23 it is determined if the image forming apparatus is printing. If the image forming apparatus is not currently printing, control flows to step S24. In step S24, the image forming apparatus 10 will go into a conventional maintenance routine for periodically ejecting ink from ink jet nozzles 48, 50, 52, and 54. In step S25, it is determined if the dye-based ink, which is black in the embodiment, is ejected onto the media to form regions 1. If the black ink is not ejected onto the media, control flows back to step S23. If the black ink is being ejected, then control flows to step S25. In step S25, the counter 40 tracks the period of time during which black inkjet nozzle 48 is ejecting ink. When the counter reaches a predetermined number, in FIG. 5, 30 seconds, the control flows to step S26 where the pigment-based ink jet nozzles 50, 52 and 54, cyan, magenta and yellow respectively in the embodiment, eject maintenance drops onto regions 1 of the media that already contain dye-based ink.

It should be appreciated that in various exemplary embodiments of the invention, the period of time where the black inkjet nozzle 48 ejects ink before proceeding to step S27 may be any period of time. In various exemplary embodiments, the period of time may be a predetermined period of time. In various other exemplary embodiments of the invention, the period of time may be adjusted up or down. The period of time the black inkjet nozzle 48 ejects ink before proceeding to step S27 may be adjusted manually by the user if the user notes a degradation in the quality of the CMY regions. The period of time that the black ink jet nozzle 48 ejects ink before proceeding to step S27 may be adjusted by a processor 25 in communication with one or more environmental condition sensors 12, 14 and 16. Based on the environmental conditions, the period of time the black ink jet nozzle ejects ink before proceeding to step S27 may be adjusted.

In another exemplary embodiment of the invention, the period of time the black ink jet nozzle 48 ejects ink before proceeding to step S27 may be adjusted by processor 26 in communication with one or more ink characteristic sensors 22. Based on the values or combination of values the ink characteristic sensors 22 send to processor 26 the period of time the black ink jet nozzle 48 ejects ink before proceeding to step S27 may be adjusted.

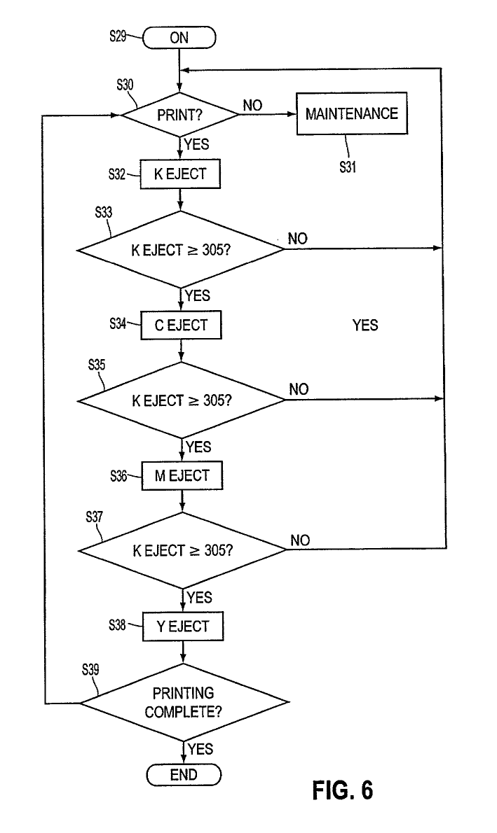

FIG. 6 illustrates another exemplary embodiment of the invention. In step 529, the image forming apparatus is switched on. In step S30 it is determined if the image forming apparatus 10 is printing. If the image forming apparatus is not currently printing, control flows to step S31. In step S31 the image forming apparatus 10 goes into a conventional maintenance routine for periodically ejecting ink from ink jet nozzles 48, 50, 52 and 54.

In step S32, it is determined if the dye-based ink, which is black in the embodiment, is ejected onto the media to form regions 1. If the black ink is not being ejected onto the media, control flows back to step S30. If the black ink is being ejected, control flows to step S33. In step S33 the counter tracks the period of time the black inkjet nozzle 48 ejects ink. When the counter reaches a predetermined time period, in step S33, 30 seconds, the control flows to step S34. If the period of time that the black ink jet nozzle 48 ejects ink does not reach 30 seconds, the control flows to step S30. In step S33 pigment-based ink jet nozzle 50 for cyan ejects maintenance drops onto regions 1 of the media that already contains dye based ink. After the ink jet nozzle 50 for cyan has ejected its maintenance drop control flows to step S35. In step S35 the counter again tracks the period of time the black inkjet nozzle 48 ejects ink. When the counter reaches a predetermined number, in step S35, 30 seconds, the control flows to step S36. If the number of ejections does not reach 30 seconds, control flows to step S30. In step S36 pigment-based ink jet nozzle 52 for magenta, ejects maintenance drops onto regions 1 on the media that already contain dye based ink. After the ink jet nozzle 52 for magenta has ejected its maintenance drops, controls flows to step S37. In step S37 the counter 40 again tracks the period of time the black inkjet nozzle 48 ejects ink. When the counter reaches a predetermined period of time, in step S37, 30 seconds, then control flows to step S38. If the period of time the black inkjet nozzle 48 ejects ink does not reach 30 seconds, the control flows to step S30. In step S38 pigment-based inkjet nozzle 54 for yellow ejects maintenance drops onto regions 1 on the media that already contain dye based ink.

Again, it should be appreciated that in various exemplary embodiments of the invention the period of time in steps S33, S35 and S37 can be any appropriate length of time. In various other exemplary embodiments of the invention the period of time may be adjusted up or down, manually, in cooperation with environmental condition sensors and/or ink characteristic sensors or any known or later developed sensor that senses a condition that affects the required maintenance schedule of inkjet nozzles 50, 52 and 54.

In other exemplary embodiments of the invention, a combination of number of ejections and length of ejection time may be suitably combined. In other exemplary embodiments of the invention a memory may be used to determine which pigment based nozzle last ejected ink, so that a pigment based nozzle which has not ejected ink and requires maintenance may eject ink at the next maintenance opportunity.

What is claimed is:

1. A fluid ejector maintenance system for use with a fluid ejector system and a recording medium, comprising:
at least two fluid ejection nozzles;
a detector that detects when at least one of the at least two fluid ejection nozzles ejects fluid onto a region of the recording medium,
a controller that controls the other of the at least two fluid ejection nozzles to eject fluid in the region where fluid was previously ejected by the at least one fluid ejection nozzle.

2. The fluid ejector maintenance system according to claim 1, wherein the controller controls the other of the at least two fluid ejection nozzles to eject fluid when the detector detects a predetermined condition.

3. The fluid ejector maintenance system according to claim 2, wherein, the predetermined condition is a number of fluid ejections.

4. The fluid ejector maintenance system according to claim 2, wherein, the predetermined condition is a period of time.

5. The fluid ejector maintenance system according to claim 2, wherein, the predetermined condition may be manually adjusted.

6. The fluid ejector maintenance system according to claim 2, wherein, the predetermined condition may be adjusted by the controller according to fluid characteristics.

7. The fluid ejector maintenance system according to claim 2, wherein, the predetermined condition may be adjusted by the controller according to environmental conditions.

8. An ink jet printer including the fluid ejector maintenance system according to claim 1.

9. A method of maintaining a fluid ejector system including at least two fluid ejection nozzles and a recording medium comprising:
detecting at least one of the at least two fluid ejection nozzles when said at least one fluid ejection nozzle ejects fluid onto a region of the recording medium;
controlling the other of the at least two fluid ejection nozzles to eject fluid from said other at least two fluid ejection nozzles in the region of the recording medium where fluid was previously ejected by the at least two fluid ejection nozzles.

10. The method of maintaining a fluid ejector system according to claim 9, wherein the detecting step further includes detecting a predetermined condition with the detector;
the controlling step further includes controlling the other of the at least two fluid ejection nozzles to eject fluid when the detector detects the predetermined condition.

11. The method of maintaining a fluid ejector system according to claim 9, wherein:
the predetermined condition is a number of fluid ejections.

12. The method of maintaining a fluid ejector system according to claim 9, wherein:
the predetermined condition is a period of time.

13. The method of maintaining a fluid ejector system according to claim 9, wherein:
the predetermined condition may be manually adjusted.

14. The method of maintaining a fluid ejector system according to claim 9, wherein:
the predetermined condition may be adjusted by the controller according to fluid characteristics.

15. The method of maintaining a fluid ejector system according to claim 9, wherein:
the predetermined condition may be adjusted by the controller according to environmental conditions.

16. A fluid ejector maintenance system for use with a fluid ejector system and a recording medium, comprising:
at least two fluid ejection nozzles;
means for detecting when at least one of the at least two fluid ejection nozzles ejects fluid onto a region of the recording medium;
means for controlling the other of the at least two fluid ejection nozzles to eject fluid in the region of the recording medium where fluid was previously ejected by the at least two fluid ejection nozzles.
